(19) United States
(12) Patent Application Publication
(10) Pub. No.: US 2002/0114906 A1
(43) Pub. Date: Aug. 22, 2002

(54) Base body for photosensitive drum and photosensitive drum using the same

(75) Inventors: Munenori Iizuka, Kodaira-shi (JP); Takahiro Suzuki, Kodaira-shi (JP); Kunio Machida, Suginami-ku (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: BRIDGESTONE CORPORATION

(21) Appl. No.: 09/988,283

(22) Filed: Nov. 19, 2001

(30) Foreign Application Priority Data
Nov. 20, 2000 (JP) 2000-353286
Nov. 20, 2000 (JP) 2000-353320
Nov. 20, 2000 (JP) 2000-353380
Nov. 24, 2000 (JP) 2000-357751
Dec. 8, 2000 (JP) 2000-373710

(51) Int. Cl. B32B 1/08

(52) U.S. Cl. 428/36.9; 430/69

(57) ABSTRACT

Cylindrical base bodies for photosensitive drums according to first to fifth inventions are each formed by using a conductive resin composition containing a resin base material and a conductive agent dispersed in the resin base material. The base body of the first invention is characterized in that a dimensional accuracy is enhanced by using a mixture of a polyamide and a low water absorption resin as the conductive resin composition. The base body of the second invention is characterized in that a uniform and stable conductivity is obtained by using carbon black having a specific DBP oil absorption amount as the conductive agent. The base bodies of the third and fourth inventions are characterized in that a surface smoothness and a strength are enhanced by using a micro-spherical material or a flaked shape material, or a fibrous inorganic material having a specific fiber length and a specific fiber diameter as an inorganic filler for reinforcement added to the conductive resin composition. The base body of the fifth invention is characterized in that occurrence of charging noise is suppressed by using a composition having a specific tan δ as the conductive resin composition.

### BACKGROUND OF THE INVENTION

The present invention relates to a base body for a photosensitive drum, which is used as a cylindrical base body of a photosensitive drum of an electrophotographic apparatus or an electrostatic recording apparatus such as a copying machine, a facsimile, or a printer, and a photosensitive drum using the base body.

An electrostatic recording process using a copying machine, a facsimile, or a printer generally includes the steps of uniformly, electrically charging a surface of a photosensitive drum, projecting an image from an optical system onto the surface of the photosensitive drum for erasing electric charges on a portion irradiated with light, to form an electrostatic latent image, supplying toner onto the electrostatic latent image, to form a toner image by electrostatic adhesion, and transferring the toner image on a recording medium such as general paper, transparency sheet for OHP, or photographic paper, thereby printing the image on the recording medium.

A conventional photosensitive drum used in such an electrostatic recording process generally has a structure shown in FIG. 1.

As shown in FIG. 1, the conventional photosensitive drum includes a cylindrical base body 1 having a good conductivity, wherein two flanges 2a and 2b are fixedly inserted in both ends of the cylindrical base body 1, and a photosensitive layer 3 is formed on an outer peripheral surface of the cylindrical base body 1. In general, as shown in FIG. 1, the photosensitive drum 1 is rotatably supported by a main body “a” of an electrophotographic apparatus in such a manner that two supporting shafts 4 provided on the main body “a” are inserted in two shaft holes 5 provided in the flanges 2a and 2b. A gear 7 connected to a drive source such as a motor is meshed with a drive gear 6 formed on one flange 2b, whereby the photosensitive drum is rotated by the drive source.

The cylindrical base body 1 has been made from an aluminum alloy because of its advantages such as relatively light weight, good machinability, and good conductivity.

The cylindrical base body made from an aluminum alloy, however, has the following problems: namely, parts of the cylindrical base body must be each machined at a high accuracy in order to satisfy requirements for a strict dimensional accuracy and a surface roughness of the cylindrical base body; both ends of the cylindrical base body must be machined for allowing the flanges 2a and 2b to be fixedly inserted therein; and a surface treatment must be performed, as needed, in order to prevent oxidation of the surface of the cylindrical base body, with a result that the number of production steps becomes large, to raise the production cost of the cylindrical base body. An aluminum alloy, therefore, is not necessarily desirable as the material of the cylindrical base body used for a photosensitive drum.

In place of the above-described cylindrical base body made from an aluminum alloy, there has been used a cylindrical base body formed by a resin pipe obtained by injection-molding a conductive resin composition containing a thermoplastic resin and a conductive agent such as carbon dispersed in the resin. Such a resin made base body is advantageous in that various machining steps required for producing the aluminum alloy made base body can be omitted; the weight of a photosensitive drum using the base body can be reduced; and by molding flanges and a drive gear integrally with the base body, conduction between the flanges and drive gear and the base body can be significantly stabilized.

The resin made base body for a photosensitive drum, however, is not necessarily desirable in terms of dimensional stability. Specifically, a polyamide resin is often used as a resin base material of a conductive resin composition for forming the resin made base body for a photosensitive drum because the base body using the polyamide resin exhibits a surface smoothness desirable for forming a photosensitive layer thereon and has a relatively good chemical resistance and a relatively good mechanical strength; however, dimensions of the base body using the polyamide resin are liable to be changed with elapsed time due to a moisture absorption property of the polyamide resin, thereby often causing an image failure.

To solve such a problem, a surface of a base body made from a resin, typically, a polyamide resin, which base body is used for a photosensitive drum, has been covered with a moisture proof coat layer for preventing a dimensional change of the base body due to moisture absorption of the resin. The covering of the base body with such a moisture proof coat layer becomes one of causes of the raised production cost of the photosensitive drum.

Accordingly, it is expected to provide a method of effectively preventing a dimensional change of a base body for a photosensitive drum due to moisture absorption of a resin for forming the base body without provision of any moisture proof layer on a surface of the base body.

On the other hand, although a carbon powder such as carbon black is used as a conductive agent contained in a conductive resin composition for forming a base body for a photosensitive drum, such carbon black must be contained in the resin composition in an amount being as large as 25 wt % or more for ensuring a conductivity of the base body in a range of 10³ to 10⁴ Ω. As a result, it becomes often difficult to desirably knead the resin composition and/or plasticize the resin composition upon injection molding, thereby causing a variation in conductivity of the molded base body, whereby the conductivity of the base body becomes unstable.

The variation in conductivity of the base body caused depending on the content of carbon black will be more fully described. In the case of kneading a resin containing carbon black by a biaxial kneader or the like, if the content of carbon black is large, the kneading characteristic is correspondingly reduced, so that it becomes difficult to uniformly disperse the carbon black in the resin, and further, a shearing force given to the material becomes large during kneading, to break a structure of carbon black, thereby failing to obtain a desired conductivity and causing a variation in conductivity. Further, in the case of injection-molding a conductive resin composition obtained by kneading the resin containing carbon black, at the step of plasticizing the resin composition by a cylinder screw at the time of injection molding, there occurs breakage of the structure of carbon black by a shearing force caused by the screw, with a variation in breakage (of the structure of carbon black) becoming large, so that the conductivity of the molded product becomes unstable. The addition of carbon black in a large amount causes a further problem that the strength of the base body is degraded.

Accordingly, it is expected to develop a technique of providing a base body for a photosensitive drum, which is capable of certainly obtaining a uniform and stable conductivity of the base body.

In the case of forming a base body for a photosensitive drum by using a conductive resin composition, a fibrous material in the form of fibers such as carbon fibers, whiskers, or glass fibers is generally added as a reinforcing filler to the resin composition in a suitable amount for the purpose of reinforcement and weighting.

The addition of the reinforcing filler reduces a surface smoothness of the molded product. The reduction in surface smoothness of the base body for a photosensitive drum directly reduces a productivity and a performance of the photosensitive drum.

Specifically, in the case of covering an outer peripheral surface of a cylindrical resin base body with a photosensitive layer by coating to obtain a photosensitive drum, if the surface smoothness of the surface of the base body is degraded, there occurs a coating failure at the step of coating the surface of the base body with a photosensitive agent, and further there occurs an abnormality in charging characteristic on the surface having micro irregularities of the photosensitive drum, to cause a serious problem such as image deterioration.

In this regard, a high surface smoothness specified such that a center line average height Ra is less than 0.2 μm and a maximum height Rmax is less than 0.8 μM is often required for a base body for a photosensitive drum, and in this case, the reduction in surface smoothness due to addition of a reinforcing filler presents a serious problem.

The addition of a reinforcing filler thus becomes one of causes of the reduction in surface smoothness of a base body for a photosensitive drum; however, if the addition of the reinforcing filler is omitted or the content thereof is reduced, it becomes difficult to obtain a sufficient mechanical strength of the base body for a photosensitive drum.

Accordingly, it is expected to develop a technique of providing a base body for a photosensitive drum, molded from a conductive resin composition, which is capable of improving a surface smoothness of the base body while keeping a sufficient mechanical strength.

The conventional photosensitive drum has a further problem that noise occurs at a charging step by a contact charging method. Specifically, a surface of a photosensitive drum is uniformly, electrically charged by a bias voltage applied from a charging roller or the like thereto, and an image is projected from an optical system onto such a charged surface, to form an electrostatic latent image, and in this case, a so-called charging noise occurs when the bias voltage is applied to the surface of the photosensitive drum.

In the case of using a base body for a photosensitive drum, which is made from an aluminum alloy, the degree of occurrence of charging noise becomes significant; however, even in the case of using a resin made base body for a photosensitive drum, there occurs charging noise. In particular, if the contact charging method is carried out by applying a voltage obtained by superimposing an AC voltage with a DC voltage on the surface of the photosensitive drum for charging the surface thereof, the degree of occurrence of charging noise becomes significant.

Accordingly, it is expected to provide a base body for a photosensitive drum used in an environment requiring stillness, which is capable of suppressing occurrence of charging noise.

### SUMMARY OF THE INVENTION

A first object of the present invention is to provide a base body for a photosensitive drum, which is capable of solving a problem associated with a dimensional change of the base body due to moisture absorption without reducing performances of the base body, such as a surface smoothness, a chemical resistance, and a mechanical strength thereof, thereby omitting formation of a moisture proof coat layer, and to provide a photosensitive drum using the base body.

A second object of the present invention is to provide a base body for a photosensitive drum, which is capable of certainly obtaining a uniform and stable conductivity, and to provide a photosensitive drum using the base body.

A third object of the present invention is to provide a base body for a photosensitive drum, which is capable of solving a problem associated with a reduction in surface smoothness due to addition of a reinforcing filler, thereby improving the surface smoothness while keeping a sufficient mechanical strength, and to provide a photosensitive drum using the base body.

A fourth object of the present invention is to provide a base body for a photosensitive drum, which is capable of reducing noise at the time of electrical charging, thereby improving stillness in an electrophotographic process, and to provide a photosensitive drum using the base body.

To achieve the first object, the present inventor has earnestly studied a cylindrical base body for a photosensitive drum, which is formed by using a conductive resin composition containing a resin base material and a conductive agent, and has found that a moisture absorption degree of the resin composition can be effectively reduced, to prevent a dimensional change of the base body due to moisture absorption as much as possible, thereby omitting a moisture proof coat layer which has been formed on a surface of a conventional resin base body for a photosensitive drum, by a manner of mixing a suitable amount of a low water absorption resin such as polypropylene, polyphenylene ether, or polyphenylene sulfide with a polyamide resin, to obtain the resin base material, preparing the conductive resin composition by mixing the conductive agent with such a resin base material, and forming the base body for a photosensitive drum by using the resin composition. On the basis of the above knowledge, the first invention has been accomplished.

Therefore, to achieve the first object, according to the first invention, there are provided a base body for a photosensitive drum, which is obtained by molding a conductive resin composition into a cylindrical shape, the resin composition containing a resin base material and a conductive agent, wherein the resin base material is a mixed resin of a polyamide resin and a low water absorption resin; and a photosensitive drum including a cylindrical base body, which is obtained by molding a conductive resin composition into a cylindrical shape, and a photosensitive layer formed on an outer peripheral surface of the cylindrical base body, wherein the resin composition contains a resin base material and a conductive agent, and the resin base material is a mixed resin of a polyamide resin and a low water absorption resin.

To achieve the above second object, the present invention has earnestly studied a cylindrical base body for a photosensitive drum, which is formed by using a conductive resin composition containing a resin base material and a conductive agent, and has found that a kneading characteristic of the resin base material and the moldability of the resin composition can be effectively improved by using carbon black with its structure (high-order structure) sufficiently grown as the conductive agent, and a conductive performance of the base body for a photosensitive drum can be enhanced by effectively reducing breakage of the structure of the carbon black. Concretely, w it has been found that conductive carbon black enhances a conductivity of electrons because of its specific structure to give a higher conductivity of the base body, and as the degree of the growth of the structure of carbon black becomes large, the conductivity of the base body becomes higher even if an amount of carbon black is reduced, and that the performance of the base body can be effectively prevented from being deteriorated by breakage of the structure of carbon black at the time of kneading and injection-molding by using carbon black with its structure sufficiently grown, that is, reducing the added amount of the carbon black, thereby stabilizing the conductivity of the base body for a photosensitive drum.

As a result of further examination on an index expressing the degree of the growth of the above structure of carbon black, which is required to achieve the second object, it has been found that a DBP (dibutyl phthalate) oil absorption amount can be taken as a suitable index expressing the degree of the growth of the structure of carbon black, and that a sufficient conductivity of the base body for a photosensitive drum can be certainly obtained by using carbon black having the DBP oil absorption amount in a range of 130 ml/100 g or more, preferably, 150 ml/100 g, even if the added amount of the carbon black is reduced, and more specifically, the conductivity of the base body for a photosensitive drum can be certainly stabilized by effectively reducing the added amount of the carbon black specified as described above, thereby effectively preventing the performances due to breakage of the structure of the carbon black at the time of kneading and injection molding. On the basis of the above knowledge, the second invention has been accomplished.

Therefore, according to the second invention, there are provided a base body for a photosensitive drum, which is obtained by molding a conductive resin composition into a cylindrical shape, the resin composition containing a resin base material and a conductive agent, wherein the conductive agent is carbon black having a DBP oil absorption amount in a range of 130 ml/100 g or more; and a photosensitive drum including a cylindrical base body, which is obtained by molding a conductive resin composition into a cylindrical shape, and a photosensitive layer formed on an outer peripheral surface of the cylindrical base body, wherein the resin composition contains a resin base material and a conductive agent, and the conductive agent is carbon black having a DBP oil absorption amount in a range of 130 ml/100 g or more.

To achieve the third object, the present inventor has earnestly studied a cylindrical base body for a photosensitive drum, which is formed by using a conductive resin composition containing an inorganic filler for reinforcement, and has found that it is possible to improve a surface smoothness of the base body while keeping a sufficient mechanical strength thereof by using micro-spherical material and/or a flake-shaped material as the inorganic filler for reinforcement.

As a result of further examination, it has been found that in the case of mixing micro-spherical material such as glass beads, silica balloons, or fly ash in a resin, particles of the micro-spherical material are finely dispersed in the resin, that is, not aggregated in the resin, so that the micro-spherical material does not reduce the surface smoothness of the molded product, and in the case of mixing flake-shaped material such as aluminum flakes, Ni-coated mica, muscovite, or phlogopite, each of particles of the flake-shaped material has a large aspect ratio, so that the flake-shaped material has a large effect of improving a mechanical strength of the base body, with a result that the mechanical strength of the base body can be sufficiently improved without reducing a surface smoothness thereof so much, even if an added amount of the flake-shaped material is reduced; and that it is possible to ensure a sufficient mechanical strength of the base body while keeping a good surface smoothness thereof by using the micro-spherical material and/or the flake-shaped material as the reinforcing filler.

Therefore, to achieve the above third object, according to the third invention, there are provided a base body for a photosensitive drum, which is obtained by molding a conductive resin composition into a cylindrical shape, the resin composition containing an inorganic filler for reinforcement, wherein the inorganic filler for reinforcement is either or both of a micro-spherical inorganic material and a flake-shaped inorganic material; and a photosensitive drum including a cylindrical base body, which is obtained by molding a conductive resin composition into a cylindrical shape, and a photosensitive layer formed on an outer peripheral surface of the cylindrical base body, wherein the resin composition contains an inorganic filler for reinforcement, and the inorganic filler for reinforcement is either or both of a micro-spherical inorganic material and a flake-shaped inorganic material.

To achieve the third object, the present inventor has additionally studied a cylindrical base body for a photosensitive drum, which is formed by using a conductive resin composition containing an inorganic filler for reinforcement, and has found that it is possible to obtain an effect of sufficiently reinforcing the base body while keeping a good surface smoothness thereof capable of satisfying a specification regarding a surface roughness, in which a center line average height Ra is less than 0.2 μm and a maximum height Rmax is less than 0.8 μm, by using a fibrous inorganic material in the form of fine fibers each having a length of 8 to 50 μm and a diameter of 0.1 to 5 μm. On the basis of the above knowledge, the fourth invention has been accomplished.

Therefore, to achieve the third object, according to the fourth invention, there are provided a base body for a photosensitive drum, which is obtained by molding a conductive resin composition into a cylindrical shape, the resin composition containing an inorganic filler for reinforcement, wherein the inorganic filler for reinforcement is a fibrous inorganic material in the form of fibers each having a length ranging from 8 to 50 μm and a diameter ranging from 0.1 to 5 μm; and a photosensitive drum including a cylindrical base body, which is obtained by molding a conductive resin composition into a cylindrical shape, and a photosensitive layer formed on an outer peripheral surface of the cylindrical base body, wherein the resin composition contains an inorganic filler for reinforcement, and the inorganic filler for reinforcement is a fibrous inorganic material in the form of fibers each having a length ranging from 8 to 50 μm and a diameter ranging from 0.1 to 5 μm.

To achieve the above fourth object, the present inventor has earnestly studied the cause of occurrence of charging noise of a photosensitive drum, and has found that since the charging noise of the photosensitive drum occurs by the fact that a base body for the photosensitive drum is vibrated by applying a voltage thereto, the charging noise can be reduced by lowering the occurrence of vibration of the base body, and that since a frequency characteristic of a material of the base body exerts an effect on the vibration of the base body, the charging noise can be effectively reduced by optimizing the frequency characteristic of the material of the base body.

As a result of further examination, it has been found that it is possible to reduce charging noise of a photosensitive drum by optimizing a factor tan δ expressing a frequency characteristic of a material of a base body of the photosensitive drum, and specifically, to effectively reduce the charging noise of the photosensitive drum by setting the factor tan δ of the material of the base body of the photosensitive drum to a value of 0.05 or more, which cannot be obtained for a metal material such as an aluminum alloy, and that it is possible to reduce charging noise of a photosensitive drum by forming a base body for the photosensitive drum using a conductive resin composition having the factor tans in a range of 0.05 or more. On the basis of the above knowledge, the fifth invention has been accomplished.

Therefore, to achieve the above fourth object, according to the fifth invention, there are provided a base body for a photosensitive drum, which is obtained by molding a conductive resin composition into a cylindrical shape, wherein the resin composition has a factor tans expressing a frequency characteristic of the resin composition measured by an one-end fixation method using an apparatus for measuring a complex modulus of elasticity, which factor is in a range of 0.05 or more; and a photosensitive drum including a cylindrical base body, which is obtained by molding a conductive resin composition into a cylindrical shape, and a photosensitive layer formed on the cylindrical base body, wherein the resin composition has a factor tan δ expressing a frequency characteristic of the resin composition measured by an one-end fixation method using an apparatus for measuring a complex modulus of elasticity, which factor is in a range of 0.05 or more.

### BRIEF DESCRIPTION OF THE DRAWING

FIG. 1 is a schematic sectional view showing one example of a photosensitive drum.

### DETAILED DESCRIPTION OF THE INVENTION

Hereinafter, first to fifth inventions will be described in detail.

First Invention

A first invention will be described below.

A base body for a photosensitive drum according to the first invention is formed by using a resin composition obtained by mixing a conductive agent with a mixed resin of a polyamide resin and a low water absorption resin.

Specific examples of the polyamide resins each used as the basic resin of the conductive resin composition may include polyamide(nylon) 11, polyamide(nylon) 12, polyamide(nylon) 46, polyamide(nylon) 6, polyamide(nylon) 66, polyamide(nylon) MXD6, polyamide(nylon) 610, polyamide(nylon) 612, polyamide(nylon) 1212, and copolymers thereof. One kind or two or more kinds of these resins can be used. In particular, polyamide(nylon) 66 and polyamide(nylon) MXD6 are preferably used in terms of moldability, heat resistance, mechanical characteristics, chemical resistance, material cost, and the like.

According to the first invention, the mixed resin of the above-described polyamide resin and a low water absorption resin is used as the resin base material of the conductive resin composition. As the low water absorption resin, there is used a resin having a water absorption specified under ASTM-D570, which percentage is set, while not limited thereto, in a range of 0.3% or less, preferably, 0.1% or less. The addition of the low water absorption resin reduces a moisture absorption degree of the whole resin composition, and hence makes a dimensional change of the base body, which is made from the resin composition and is used for a photosensitive drum, due to moisture absorption as small as possible.

Specific examples of the low water absorption resins may include polyethylene (PE), polypropylene (PP), ABS, polyphenylene ether (PPE), polyphenylene sulfide (PPS), polybutylene terephthalate (PBT), polyethylene terephthalate (PET), polyarylate (PAR), and polycarbonate (PC). One kind or two or more kinds of these resins can be used. In particular, polypropylene, polyphenylene ether, and polyphenylene sulfide are preferably used.

A content of the low water absorption resin is suitably selected depending on a kind of the low water absorption resin and a kind of the polyamide resin but may be set, while not limited thereto, in a range of 1 to 70 wt %, preferably, 5 to 50 wt %, more preferably, 10 to 40 wt %. If the content is less than 1%, the water absorption degree of the resin composition may be not sufficiently reduced, and if the content is more than 70 wt %, properties (for example, surface smoothness, chemical resistance and mechanical strength) of the resin composition depending on properties of the polyamide resin may be degraded. In the case of mixing the low water absorption resin with the polyamide resin, while not exclusively, a compatibility enhancing agent can be added for increasing a compatibility between these resins, to improve the dispersibility of the low water absorption resin in the polyamide resin, thereby enhancing the mechanical characteristics, moisture resistance, and chemical resistance of the resin composition. As the compatibility enhancing agent, there is used a resin having a high compatibility to both the polyamide resin and the low water absorption resin. For example, in the case of using polypropylene as the low water absorption resin, maleic acid modified polypropylene is used as the compatibility enhancing agent, and in the case of using polyphenylene sulfide or polyphenylene ether as the low water absorption resin, polystyrene-polymethyl methacrylate copolymer is used as the compatibility enhancing agent.

An added amount of the compatibility enhancing agent may be set, while not limited thereto, in a range of 2 to 15 wt %, preferably, 3 to 10 wt % on the basis of the total weight of the conductive composition.

The conductive resin composition is usually obtained by adding a conductive agent to the above-described resin base material for imparting a conductivity. As the conductive agent, there can be used any conductive material insofar as it can be uniformly dispersed in the resin. Specific examples of the conductive agents may include carbon black, graphite, metal powders of aluminum, copper, nickel, and the like, and a conductive glass powder. In particular, carbon black is preferably used. An added amount of the conductive agent may be set, while not limited thereto, in a range of 5 to 30 wt %, preferably, 5 to 20 wt % on the basis of the total weight of the resin composition. More specifically, the added amount of the conductive agent may be set such that a surface resistance of a molded product is in a range of 10⁴ Ω/□ (ohm/square) or less, preferably, 10² Ω/□ or less.

An inorganic filler such as fibers can be added to the conductive resin composition for the purpose of reinforcement and weighting. As the inorganic filler, there can be used a fibrous inorganic material, for example, conductive fibers such as carbon fibers, conductive whiskers or conductive glass fibers, or non-conductive fibers such as whiskers or glass fibers. Since the conductive fibers act as a conductive agent, the use of the conductive fibers can reduce the content of the above-described carbon black.

A content of the filler is suitably selected depending on a kind, a length, and a diameter of each fiber as the filler but may be set, while not limited thereto, in a range of 1 to 30 wt %, preferably, 5 to 25 wt %, more preferably, 10 to 25 wt % on the basis of the total weight of the resin composition.

In addition to the above-described carbon black and filler, known additives such as polytetrafluoroethylene (PTFE), silicone, molybdenum dioxide (MOS₂), and various metal soaps can be added in suitable amounts to the conductive resin composition. Additionally, the filler may be subjected to surface treatment by using a known silane coupling agent or titanate coupling agent.

Second Invention

A second invention will be described below.

A base body for a photosensitive drum according to the second invention is obtained by molding a conductive resin composition into a cylindrical shape, wherein the resin composition is obtained by dispersing carbon black having a DBP oil absorption amount of 130 ml/100 g or more in a resin base material.

As the resin base material of the conductive resin composition, while not exclusively, there is preferably used a thermoplastic resin or a resin material mainly containing a thermoplastic resin. The thermoplastic resin may be selected from known resin materials which have been used for a base body for a photosensitive drum, and preferably, selected from polyamide resins such as nylons in terms of good surface smoothness required for forming a photosensitive layer, and excellent chemical resistance and mechanical strength. Concretely, one or more of the polyamide resins described in the first invention can be used. In particular, the polyamide resin obtained from metaxylylene diamine and adipic acid and/or the polyamide resin obtained from ε-caprolactam are preferably used.

It is to be noted that the polyamide resin produced by polycondensation of metaxylylene diamine and adipic acid is generally called “nylon MXD6”, and the polyamide resin produced by ring-opening polymerization of ε-caprolactam is generally called “nylon 6”.

According to the second invention, a mixture of a plurality of polyamide resins may be used as the resin base material. For example, a mixture of nylon MXD6 and/or nylon 6 and another polyamide resin may be used. In this case, another polyamide resin is not particularly limited but may be selected from polyamide(nylon) 11, polyamide(nylon) 12, polyamide(nylon) 46, polyamide(nylon) 66, polyamide(nylon) 610, polyamide(nylon) 612, polyamide(nylon) 1212, and copolymers thereof. In the case of mixing another polyamide resin with nylon MXD6 and/or nylon 6, the content of nylon MXD6 and/or nylon 6 may be set, while not limited thereto, in a range of at least 30 to 100 wt %, preferably, 40 to 100 wt % on the basis of the resin base material of the resin composition.

The resin base material may include, in addition to the above polyamide resin, another kind of resin which is selected from general thermoplastic resins such as polyethylene, polypropylene, ABS, polybutylene terephthalate, polyethylene terephthalate, polycarbonate, polyphenylene ether, and polyphenylene sulfide. In particular, polyethylene, polypropylene, polyphenylene ether, or polyphenylene sulfide is preferably used as another kind of resin.

According to the second invention, carbon black used as the conductive agent is specified such that the DBP oil absorption amount thereof is in a range of 130 ml/100 g or more, preferably, 180 ml/100 g or more. If the DBP oil absorption amount of the carbon black is less than 130 ml/100 g, the growth of the structure of the carbon black is insufficient, so that the conductivity of the carbon black is poor. As a result, a large amount of the carbon black must be added for allowing the base body for a photosensitive drum to exhibit a sufficient conductivity and thereby the kneading characteristic and moldability of the conductive resin composition are degraded, and further, since the degree of breakage of the structure of the carbon black upon kneading and injection molding becomes large, it fails to give a sufficient conductivity to the base body for a photosensitive drum.

The DBP oil absorption amount is measured under JIS K6217 by using an absorptiometer. Specifically, dibutyl phthalate is added to carbon black, and an oil absorption amount is measured, the unit thereof being converted to ml/100 g.

A content of the carbon black may be set, while not limited thereto, in a range of 30 wt % or less, preferably, wt % or less, more preferably, 1 to 30 wt %, most preferably, 13 to 20 wt % on the basis of the total weight of the resin composition. According to the second invention, carbon black whose structure is sufficiently grown to thereby enhance the conductivity thereof is added, and accordingly, even if an added amount of the carbon black is relatively small, a resistance of the base body for a photosensitive drum can be set in a range of 10⁴ Ω/□ (ohm/square) or less, preferably, 10² Ω/□ or less.

Like the first invention, various inorganic fillers and known additives may be added to the conductive resin composition for forming the base body for a photosensitive drum according to the second invention. The concrete kinds and added amounts thereof are the same as those described in the first invention.

Third Invention and Fourth Invention

A third invention and a fourth invention will be described below.

A base body for a photosensitive drum according to each of the third and fourth inventions is formed by using a conductive resin composition containing an inorganic filler for reinforcement, wherein a micro-spherical material and/or a flake-shaped material are used as the inorganic filler for reinforcement in the third invention, and a fibrous inorganic material in the form of fibers each having a length of 8 to 50 μm and a diameter of 0.1 to 5 μm is used as the inorganic filler for reinforcement.

As a resin base material of the conductive resin composition, while not exclusively, there is preferably used a thermoplastic resin or a resin material mainly containing a thermoplastic resin. The thermoplastic resin may be selected from known resin materials which have been used for a base body for a photosensitive drum, and preferably, selected from polyamide resins such as nylons in terms of good surface smoothness required for forming a photosensitive layer, and excellent chemical resistance and mechanical strength. Concretely, one or more of the polyamide resins described in the first invention can be used.

In this case, while not exclusively, like the second invention, the polyamide resin (nylon MXD6) obtained from metaxylylene diamine and adipic acid and/or the polyamide resin (nylon 6) obtained from ε-caprolactam are preferably used. A mixture of a plurality of polyamide resins may be used as the resin base material, and for example, as described in the second invention, a mixture of nylon MXD6 and/or nylon 6 and another polyamide resin may be used. In this case, another polyamide resin is the same as that described in the second invention, and the mixing ratio of the mixture of nylon MXD6 and/or nylon 6 and another polyamide resin is the same as that described in the second invention.

To suppress a dimensional change of a molded product due to moisture absorption, that is, a dimensional change of the molded base body for a photosensitive drum due to moisture absorption, the same low water absorption resin as that described in the first invention can be added to the above polyamide resin. For example, one kind selected from polypropylene, polyphenylene ether, polypneylene sulfide, and the like in consideration of a compatibility with the polyamide resin may be added in a suitable amount to the polyamide resin.

The conductive resin composition is generally obtained by adding a conductive agent to the above-described resin base material. In this case, any conductive agent can be used insofar as it can be uniformly dispersed in the resin base material, and concretely, the same conductive agent as that described in the first invention may be added in the same amount as that described in the first invention.

According to the base body for a photosensitive drum in each of the third and fourth inventions, as described above, a reinforcing filler is added to the conductive resin composition for improving a mechanical strength of the base body. According to the third invention, a micro-spherical material and/or a flake-shaped material are used as the reinforcing filler.

As the micro-spherical material, there may be used one kind or two or more kinds selected from glass beads, silica balloon, fly ash, and the like. Particles of the micro-spherical material have a good dispersibility. As a result, when mixed in the resin base material, the particles of the micro-spherical material are finely dispersed and thereby less aggregated. This makes it possible to effectively improve a mechanical strength of the base body for a photosensitive drum without reducing a surface smoothness thereof. In this case, an average particle size of the particles of the micro-spherical material may be set, while not limited thereto, in a range of 50 μm or less. If the average particles size is more than 50 μm, the surface smoothness of the base body may be degraded.

Since the particles of the micro-spherical material are desirably, finely dispersed and thereby less aggregated in the resin base material, even if a large amount of the micro-spherical material is added, the surface smoothness of the base body for a photosensitive drum is not degraded so much, with a result that the mechanical strength of the base body can be improved by adding a sufficient amount of the micro-spherical material. Concretely, a content of the micro-spherical material may be set in a range of 10 to 25 wt %, preferably, 15 to 20 wt % on the basis of the total weight of the conductive resin composition.

As the flake-shaped material, one kind or two or more kinds selected from aluminum flakes, Ni-coated mica, muscovite, phlogopite, and the like can be used. Such a flake-shaped material has an effect of improving a mechanical strength of the base body because an aspect ratio (length/thickness) thereof is large. Accordingly, by adding the flake-shaped material as the reinforcing filler, it is possible to enhance the surface smoothness of the base body while keeping a sufficient mechanical strength thereof by reducing an added amount of the flake-shaped material. In this case, the aspect ratio (length/thickness) of the flake-shaped material may be set, while not limited thereto, in a range of 10 to 70, preferably, 20 to 65. If the aspect ratio of the flake-shaped material is less than 10, the addition of the flake-shaped material in a small amount fails to give a sufficient strength to the base body by, and the addition of the flake-shaped material in a large amount for ensuring a sufficient strength of the base body may degrade the surface smoothness of the base body. On the other hand, if the aspect ratio of the flake-shaped material is more than 70, it may fail to ensure a good surface smoothness of the base body.

The flake-shaped material has a desirable effect of improving the strength of the base body as described above. As a result, it is possible to obtain a sufficient mechanical strength of the base body for a photosensitive drum without reducing the surface smoothness thereof by adding the flake-shaped material in a relatively small amount. A content of the flake-shaped material may be set in a range of 10 to 25 wt %, preferably, 15 to 20 wt % on the basis of the total weight of the conductive resin composition.

As the inorganic filler for reinforcement of the conductive resin composition used in the third invention, both the micro-spherical material and the flake-shaped material may be used in combination, as needed. The addition of these two materials in combination is effective to compensate the disadvantages of the two materials with each other, and hence to positively improve the mechanical strength of the base body while keeping the surface smoothness thereof by the synergistic effect of the two materials.

According to the base body for a photosensitive drum in the fourth invention, a fibrous inorganic material in the form of fine fibers each having a length of 8 to 50 μm and a diameter of 0.1 to 5 μm is used as the inorganic filler for reinforcement. Any kind of the fibrous inorganic material may be used insofar as it can satisfy the above requirements associated with the fiber length and fiber diameter. Specific examples of the fibrous inorganic materials may include glass fibers, carbon fibers, and fibers of potassium titanate, barium titanate, strontium titanate, lead titanate, aluminum borate, silicon carbide, basic magnesium sulfate, zinc oxide, calcium sulfate, calcium carbonate, magnesium borate, and calcium silicate. One kind or two or more kinds of these materials may be used. In particular, whisker based fibers of potassium titanate, aluminum borate, silicon carbide, basis magnesium sulfate, zinc oxide, calcium sulfate, magnesium borate, and calcium silicate are preferably used. The use of such whisker based fibers is effective to obtain a resin composition having a high elastic modulus and a high strength because a fiber diameter and fiber length are relatively fine and also an elastic modulus of the fiber is high and an aspect ratio of the fiber is high.

A content of the above fibrous inorganic material is suitably selected depending on the kind thereof, the length and diameter of the fiber, and the like, but may be set, while not limited thereto, in a range of 1 to 30 wt %, preferably, 5 to 25 wt %, more preferably, 10 to 25 wt % on the basis of the total weight of the resin composition. The addition of the fibrous inorganic material capable of satisfying the above-described requirements associated with the fiber length and fiber diameter makes it possible to effectively improve the strength and rigidity of a molded product without reducing the surface smoothness thereof.

According to the base body for a photosensitive drum in each of the third and fourth inventions, as the inorganic filler for reinforcement, there can be used the fibrous inorganic material in combination with the micro-spherical material and/or the flake-shaped material. In this case, while not exclusively, the fibrous inorganic material may be used for assisting the reinforcing effect of the micro-spherical material and/or the flake-shaped material, and the content of the fibrous inorganic material may be reduced. Concretely, the content of the fibrous inorganic material may be set in a range of 5 to 30 wt %, preferably, 8 to 20 wt % on the basis of the total weight of the resin composition.

Like the first and second inventions, known additives may be added to the conductive resin composition for forming the base body for a photosensitive drum according to each of the third and fourth inventions. In this case, the concrete kinds and added amounts thereof are the same as those described in the first invention.

Fifth Invention

A fifth invention will be described below.

A base body for a photosensitive drum according to the fifth invention is obtained by forming a conductive resin composition having a factor tans expressing a frequency characteristic in a range of 0.05 or more into a cylindrical shape.

As a resin base material of the conductive resin composition, while not exclusively, there is preferably used a thermoplastic resin or a resin material mainly containing a thermoplastic resin. The thermoplastic resin may be selected from known resin materials which have been used for a base body for a photosensitive drum, and preferably, selected from polyamide resins such as nylons in terms of good surface smoothness required for forming a photosensitive layer, and excellent chemical resistance and mechanical strength. Concretely, one kind or two or more kinds of the polyamide resins described in the first invention can be used in combination.

To suppress a dimensional change of a molded product due to moisture absorption, that is, a dimensional change of the molded base body for a photosensitive drum due to moisture absorption, the same low water absorption resin as that described in the first invention can be added to the above polyamide resin. For example, one kind selected from polypropylene, polyphenylene ether, polypneylene sulfide, and the like in consideration of a compatibility with the polyamide resin may be added in a suitable amount to the polyamide resin.

The conductive resin composition is generally obtained by adding a conductive agent to the above-described resin base material. In this case, any conductive agent can be used insofar as it can be uniformly dispersed in the resin base material, and concretely, the same conductive agent as that described in the first invention may be added in the same amount as that described in the first invention.

Like the first invention, various inorganic fillers and known additives can be added to the conductive resin composition for forming the base body for a photosensitive drum according to the fifth invention. The concrete kinds and added amounts thereof are the same as those described in the first invention. In this case, according to the fifth invention, the factor tan δ of the conductive resin composition can be controlled by adjusting the presence or absence, kinds, and mixing ratio of the inorganic fillers.

According to the fifth invention, as the inorganic filler, while not exclusively, there may be used whiskers of potassium titanate, whiskers of barium titanate, whiskers of strontium titanate, whiskers of lead titanate, whiskers of calcium silicate, whiskers of aluminum borate, whiskers of calcium carbonate, whiskers of zinc oxide, and the like. In particular, whiskers of potassium titanate, whiskers of calcium silicate, and whiskers of aluminum borate are preferably used.

According to the fifth invention, the base body for a photosensitive drum is formed into a cylindrical shape by using the conductive resin composition having the factor tan δ in the range of 0.05 or more, preferably, 0.1 or more. This is effective to prevent occurrence of charging noise as much as possible and hence to suppress noise caused upon charging of the photosensitive drum at the same level as that upon idling with no charging operation. The factor tans can be controlled by suitably selecting kinds of components of the conductive resin composition and the mixing ratio thereof, and more specifically, by adjusting the presence or absence, kinds, and the mixing ratio of the fillers.

The factor tan δ can be measured by a one-end fixation method using an apparatus for measuring a complex modulus of elasticity. To be more specific, a pellet of the conductive resin composition is hot-pressed at 240° C. and 150 kgf/cm² by a press, to form a conductive resin film having a thickness of 100 μm; the conductive resin film is taken as a test piece and is set on the measuring apparatus; and a complex modulus of elasticity of the test piece is measured.

Terms Common to First to Fifth Inventions

The base body for a photosensitive drum according to each of the first to fifth inventions is obtained by molding the conductive resin composition in each invention into a cylindrical shape. In this case, as the molding method, while not exclusively, an injection molding method may be adopted. In addition, as molding conditions such as a molding temperature and a injection pressure, there may be adopted known molding conditions depending on kinds of resin components of the conductive resin composition.

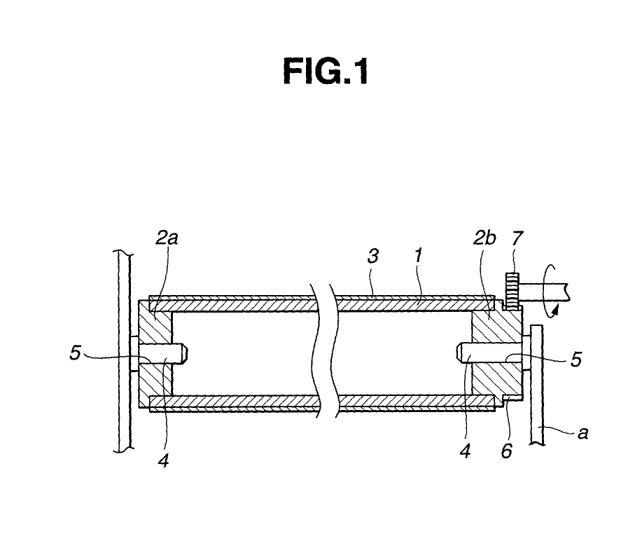

A photosensitive drum according to each of the first to fifth embodiment is obtained, as shown in FIG. 1, by forming a photosensitive layer 3 on an outer peripheral surface of a cylindrical base body 1, wherein the base body for a photosensitive drum according to each of the first to fifth inventions is used as the cylindrical base body.

In the photosensitive drum shown in FIG. 1, flanges 2a and 2b formed separately from the cylindrical base body 1 are fixedly fitted to both end surfaces of the cylindrical base body 1; however, at least one of the flanges 2a and 2b can be molded integrally with the cylindrical base body 1 by using the conductive resin composition. Further, a drive gear 6 can be molded, together with the flange, integrally with the cylindrical base body 1 by using the conductive resin composition. In particular, since the base body for a photosensitive drum according to each of the third and fourth inventions is excellent in strength and rigidity by addition of the above-described inorganic filler for reinforcement, even if the drive gear 6 is molded integrally with the cylindrical base body 1 by using the conductive resin composition, it is possible to obtain a sufficient reliability of the cylindrical base body 1.

A surface roughness of the outer peripheral surface of the cylindrical base body 1, that is, the outer peripheral surface of the base body for a photosensitive drum according to each of first to fifth inventions may be set, while not limited thereto, such that a center line average height Ra specified under JIS B0601 is in a range of 0.8 μm or less, preferably, 0.2 μm or less; a maximum height Rmax specific under JIS B0601 is in a range of 1.6 μm or less, preferably, 0.8 μm or less; and ten-point average height Rz is in a range of 1.6 μm or less, preferably, 0.8 μm or less. If the values of Ra, Rmax and Rz are excessively large, irregularities of the surface of the cylindrical base body 1 appear on the photosensitive layer 3, tending to case an image failure. In this case, according to the base body for a photosensitive drum according to each of the third and fourth inventions, it is possible to easily set the values of Ra and Rmax in the above ranges respectively, and more specifically, it is possible to set the value of Ra in a range of 0.1 μm or less and the value of Rmax in a range of 0.6 μm or less. Further, according to the base body for a photosensitive drum according to each of the third and fourth inventions, it is possible to obtain a sufficient mechanical strength of the base body while ensuring such a good surface smoothness thereof.

The photosensitive drum according to each of the first to fifth inventions is obtained by forming the photosensitive layer 3 on the outer peripheral surface of the cylindrical base body 1. In this case, the photosensitive layer 3 can be formed by using a known composition containing known materials, and the layer configuration of the photosensitive layer 3 can be the same as a known configuration.

The structure of the photosensitive drum according to each of the first to fifth inventions is not limited to that shown in FIG. 1. For example, in place of provision of shaft holes 5 in both the flanges 2a and 2b, shaft bodies (supporting shafts) projecting outwardly may be provided on both the flanges 2a and 2b, and the photosensitive drum can be rotatably mounted to a main body of an electrophotographic apparatus. The other configurations such as shapes of the flanges 2a and 2b and a rotational drive manner of the photosensitive drum can be suitably changed without departing from the scope of the present invention.

### EXAMPLE

The present invention will be more clearly understood with reference to the following inventive examples and comparative examples. It is to be noted that the present invention, however, is not limited to the examples.

### Inventive Examples 1 to 3 and Comparative Examples 1 to 3 (According to First Invention)

PA 66 (nylon 66), PPE (polyphenylene ether), PPS (polyphenylene sulfide), and PP(polypropylene), C/B (carbon black), and a reinforcing material (whiskers of potassium titanate) shown in Table 1 were mixed at each of mixing ratios shown in Table 1, to prepare a conductive resin composition. A cylindrical base body for a photosensitive drum, having an outer diameter of 30 mm, a length of 260 mm, and a peripheral wall thickness of 1.5 mm, was molded from the conductive resin composition thus prepared by an injection molding process.

The base body for a photosensitive drum thus obtained was left in a high temperature-high moisture environment with 50° C. and 95% RH for 24 hours, and a dimensional change rate of the base body was calculated from a difference in dimension of the base body before and after the test. Further, water absorption of the base body for a photosensitive drum and each of the resins (PA66, PPE, PPS, and PP) were measured under ASTM-D570. The results are shown in Table 1.

TABLE 1

| | | | | | | | | Dimensional |
|---|---|---|---|---|---|---|---|---|
| | | | | | | | | change |
| | Resin (wt %) | | | | | | | Dimensional |
| | Kind of resin | | | | Conductive | Reinforcing | | change in |
| | PA66 | PPE | PPS | PP | agent | material | Water | longitudinal |
| | Water absorption (%) | | | | C/B | Whisker | absorption | direction |
| | 1.8 | 0.10 | 0.02 | 0.01 | (wt %) | (wt %) | (%) | (%) |
| Comparative Example 1 | 80 | | | | 10 | 10 | 1.6 | 1.12 |
| Comparative Example 2 | 70 | | | | 10 | 20 | 1.5 | 1.05 |
| Comparative Example 3 | 60 | | | | 10 | 30 | 1.3 | 0.95 |
| Inventive Example 1 | 42 | 28 | | | 10 | 20 | 0.4 | 0.3 |
| Inventive Example 2 | 42 | | 28 | | 10 | 20 | 0.2 | 0.2 |
| Inventive Example 3 | 42 | | | 28 | 10 | 20 | 0.3 | 0.4 |

As shown in Table 1, the base body for a photosensitive drum, which is molded from the conductive resin composition containing the low water absorption resin is low in water absorbability and small in dimensional change, and is not required to be covered with a moisture proof coat layer.

### Inventive Examples 4 to 6 and Comparative Examples 4 to 6 (According to Second Invention)

PA (nylon 66) and PA 6 (nylon 6), whiskers (whiskers of potassium titanate), and C/B (carbon black) having each of DBP oil absorption amounts shown in Table 2 were mixed at each of mixing ratios shown in Table 2, and kneaded by a biaxial kneader, to prepare a conductive resin composition. At this time, a kneading torque during kneading operation by the biaxial kneader was measured. The results are shown in Table 2.

A cylindrical base body for a photosensitive drum, having an outer diameter of 30 mm, a length of 230 mm, and a peripheral wall thickness of 2 mm, was molded from the conductive resin composition thus prepared by an injection molding process. A surface resistance of the base body was measured. The results are shown in Table 2.

TABLE 2

| | | | | | DBP oil | Kneading | Surface |
|---|---|---|---|---|---|---|---|
| | Composition (wt %) | | | | absorption | torque | resistance |
| | PA66 | PA6 | Whisker | C/B | amount | (kgf · m) | (Ω/□) |
| Inventive Example 4 | 35 | 35 | 20 | 10 | 495 | 12 | 10 |
| Inventive Example 5 | 35 | 35 | 20 | 10 | 360 | 12 | 10² |
| Inventive Example 6 | 35 | 25 | 20 | 20 | 150 | 21 | 10² |
| Comparative Example 4 | 35 | 35 | 20 | 10 | 85 | 9 | 10¹² |
| Comparative Example 5 | 35 | 30 | 20 | 15 | 85 | 14 | 10¹⁰ |
| Comparative Example 6 | 35 | 25 | 20 | 40 | 50 | 58 | 10³ |

DBP oil absorption amount: This was measured under JIS K6217 by using an absorptiometer, wherein dibutyl phthalate was added to carbon black, and an absorption amount was measured, the unit thereof being converted to ml/100 g.

Surface resistance: This was measured by using a four probe type resistance meter “Loresta”.

Kneading Torque: This was measured as a screw torque upon biaxial kneading of a compound.

As is apparent from the results shown in Table 2, in Inventive Examples 4, 5 and 6 using the carbon black with its structure sufficiently grown to exhibit a high DBP oil absorption amount, a good conductivity of the base body can be obtained by adding the carbon black in a small amount, and since the added amount is small, the kneading torque becomes low, to enhance the kneading characteristic. On the contrary, in Comparative Example 6 using carbon black with its structure not sufficiently grown to lower the DBP oil absorption amount, the carbon black must be added in a large amount to obtain a sufficient conductivity, so that the kneading torque becomes high, to degrade the kneading characteristic. In addition, in Inventive Example 6, there occurs a variation in resistance resulting from breakage of a structure of carbon black upon kneading and molding.

### Inventive Examples 7 to 9 and Comparative Examples 7 and 8 (According to Third Invention)

Each conductive resin composition shown in Table 3 was prepared, and a cylindrical base body for a photosensitive drum, having an outer diameter of 30 mm, a length of 230 mm, and a peripheral wall thickness of 2 mm, was molded from the conductive resin composition thus prepared by an injection molding process. A surface smoothness and a mechanical strength of each base body were evaluated in the following methods. The results are shown in table 1.

Surface Smoothness

A center line average height Ra (am) and a maximum height Rmax (μm) were measured by using a surface roughness meter “SURFCOM” (sold by Tokyo Seimitsu Co., Ltd.).

Mechanical Strength

A test piece for a plastic bending test, having a thickness of 4 mm, a width of 10 mm, and a length of 800 mm, was prepared from each base body in accordance with JIS K7203 (ASTM-D790). The test piece was subjected to a three-point bending test by using an Instron-type tensile test machine.

TABLE 3

| | | | | | Comparative | |
|---|---|---|---|---|---|---|
| | | Inventive Example | | | Example | |
| | | 7 | 8 | 9 | 7 | 8 |
| Composition | PA66^{*1} | 45 | 45 | 45 | 45 | 45 |
| (wt %) | PPE^{*2} | 20 | 20 | 20 | 20 | 20 |
| | Carbon black | 15 | 15 | 15 | 35 | 15 |
| | Glass beads^{*3} | 20 | | | | |
| | Aluminum flakes^{*4} | | 20 | | | |
| | Ni-coated mica^{*5} | | | 20 | | |
| | Whiskers of potassium titanate | | | | | 20 |
| Surface Smoothness | Ra (μm) | 0.06 | 0.08 | 0.1 | 0.07 | 0.1 |
| | Rmax (μm) | 0.5 | 0.7 | 0.8 | 0.4 | 0.8 |
| Mechanical strength | 165 | 186 | 201 | 105 | 150 | |
| (bending strength/Mpa) | | | | | | |

^{*1}: nylon 66
^{*2}: polyphenylene ether
^{*3}: average particle size: 45 μm
^{*4}: aspect ratio (length/thickness): 36
^{*5}: aspect ratio (length/thickness): 45

As is shown in Table 3, the mechanical strength of the base body can be improved without reducing the surface smoothness thereof by using the micro-spherical material or a flake-shaped material as the inorganic filler for reinforcement.

### Inventive Examples 10 to 12 and Comparative Examples 9 and (According to Fourth Invention)

PA66 (“UBE nylon” sold by Ube Industries, Ltd.) in an amount of 50 wt %, PAMX6 (“RENY” sold by Mitsubishi Engineering Plastics Corp.) in an amount of 20 wt %, ketchen black (sold by Lion Corporation) in an amount of 10 wt %, and each inorganic fiber material shown in Table 4 in an amount of 20 wt % were mixed and kneaded, to prepare a conductive resin composition. A cylindrical base body for a photosensitive drum, having an outer diameter of 30 mm, a length of 230 mm, and a peripheral wall thickness of 2 mm, was molded from the conductive resin composition thus prepared by an injection molding process. A center line average height Ra and a maximum height Rmax of an outer peripheral surface of the base body thus obtained were measured by the surface roughness meter “SURFCOM” (sold by Tokyo Seimitsu Co., Ltd.). The results are shown in Table 4.

TABLE 4

| | Inorganic fiber | | | | |
|---|---|---|---|---|---|
| | | Fiber | Fiber | | |
| | | diameter | length | Ra | Rmax |
| | kind | (μm) | (μm) | (μm) | (μm) |
| Inventive | Whiskers of | 0.2 | 12 | 0.02 | 0.4 |
| Example 10 | potassium titanate | | | | |
| Inventive | Whiskers of | 0.4 | 10 | 0.04 | 0.5 |
| Example 11 | aluminum borate | | | | |
| Inventive | Whiskers of | 0.5 | 15 | 0.08 | 0.7 |
| Example 12 | calcium silicate | | | | |
| Comparative | Glass fibers | 15 | 85 | 0.31 | 5.3 |
| Example 9 | | | | | |
| Comparative | Carbon fibers | 8 | 150 | 0.56 | 8.8 |
| Example 10 | | | | | |

As shown in Table 4, the base body for a photosensitive drum, which is excellent in surface smoothness, can be obtained by using fine whiskers each having a fiber diameter of 0.1 to 5 μm and a fiber length of to 50 μm as the reinforcing filler.

### Inventive Examples 13 and 14 and Comparative Examples 11 to (According to Fifth Invention)

PA 66 (nylon 66), PA6 (nylon 6), PPE (polyphenylene ether), whiskers (whiskers of potassium titanate) and C/B were mixed at each of mixing ratios shown in Table 5, to prepare a conductive resin composition. The factor tan δ of each conductive resin composition was measured in the following method. The results are shown in Table 5.

Measurement of tan δ

A pellet of the conductive resin composition was hot-pressed at 240° C. and 150 kgf/cm² by a press, to form a conductive resin film having a thickness of 100 μm. The conductive resin film was taken as a test piece. A complex modulus of elasticity of the test piece was measured by a one-end fixation method using an apparatus for measuring a complex modulus of elasticity. In addition, a resonance frequency was set to 650 Hz.

Each conductive resin composition was injection-molded to prepare a cylindrical base body for a photosensitive drum, having an outer diameter of 30 mm, a length of 260 mm, and a peripheral wall thickness of 1.5 mm. A photosensitive layer was formed on an outer peripheral surface of the cylindrical base body, to obtain a photosensitive drum. Each photosensitive drum thus obtained was mounted to a charging noise measuring apparatus including a charging roller rotated in a state being in contact with the photosensitive drum. The photosensitive was electrically charged in the following manner, and noise at the time of charging operation was measured. The results are shown in Table 5. For comparison, a photosensitive drum obtained by forming the same photosensitive layer on an aluminum alloy base body was subjected to the same test. The result is also shown in Table 5.

Measurement of Charging Noise

The charging noise measuring apparatus was disposed in an anechoic chamber (noise upon idling with no charging: 45 dB or less), and noise (dB) containing charging noise at the time of applying a bias voltage and noise (dB) at the time of idling with no applied voltage were measured. In this case, a voltage obtained by superimposing an AC voltage of 2,000 V having each of frequencies of 530 Hz, 650 Hz, and 790 Hz to a DC voltage of −600 V was applied.

TABLE 5

| | Composition (wt %) | | | | | | Noise (dB) | | | |
|---|---|---|---|---|---|---|---|---|---|---|
| | PA66 | PA6 | PPE | Whiskers | C/B | tanξ | Idling | 530 Hz | 650 Hz | 790 Hz |
| Inventive Example 13 | 30 | | 40 | 20 | 10 | 0.8 | 36.5 | 36.5 | 36.5 | 36.5 |
| Inventive Example 14 | 30 | 40 | | 20 | 10 | 0.6 | 36 | 36 | 36 | 36 |
| Comparative Example 11 | 60 | | 30 | | 10 | 0.03 | 37 | 40 | 42 | 45 |
| Comparative Example 12 | 60 | 30 | | | 10 | 0.01 | 36 | 41 | 43 | 47 |

| | | | | | | |
|---|---|---|---|---|---|---|
| Comparative Example 13 | Aluminum alloy made drum | 0.0001 | 36.5 | 60 | 63 | 64.5 |

As is apparent from the results shown in Table 5, the base body for a photosensitive drum in each of Inventive Examples 13 and 14, which is molded from the conductive resin composition having the factor tan δ of 0.05 or more, exhibits the same noise level as that upon idling even at the time of charging, and therefore, little causes charging noise due to charging.

As described above, according to the present invention, it is possible to provide a base body for a photosensitive drum, which is capable of preventing a dimensional change due to moisture absorption as much as possible thereby omitting formation of a moisture proof coat layer having been provided, stabilizing the conductivity, and solving the problem associated with reduction in surface smoothness due to incorporation of a reinforcing filler thereby ensuring a good surface smoothness of the base body while keeping a sufficient mechanical strength thereof.

According to the present invention, it is possible to stably provide a high performance photosensitive drum using the above-described base body for a photosensitive drum, which can enhance dimensional stability, stably form a good image, and effectively suppress noise upon charging to thereby improve stillness in electrophotographic process.

While the present invention has been described using the specific terms, such description is for illustrative purposes only, and it is to be understood that changes and variations may be made without departing from the spirit or scope of the following claims.

1. A base body for a photosensitive drum, which is obtained by molding a conductive resin composition into a cylindrical shape,
said resin composition containing a resin base material and a conductive agent,
wherein said resin base material is a mixed resin of a polyamide resin and a low water absorption resin.

2. A base body for a photosensitive drum according to claim 1, wherein said low water absorption resin has a water absorption specified under ASTM-D570, which percentage is in a range of 0.3% or less.

3. A base body for a photosensitive drum according to claim 1, wherein said low water absorption resin is one kind or two or more kinds selected from polypropylene, polyphenylene ether, and polyphenylene sulfide.

4. A base body for a photosensitive drum according to claim 1, wherein said-polyamide resin is one kind or two or more kinds selected from polyamide resins including polyamide 11, polyamide 12, polyamide 46, polyamide 6, polyamide 66, polyamide MXD6, polyamide 610, polyamide 612, polyamide 1212, and copolymers thereof.

5. A base body for a photosensitive drum according to claim 1, wherein a content of said low water absorption resin is in a range of 1 to 70 wt % on the basis of the total weight of said resin base material.

6. A base body for a photosensitive drum according to claim 1, wherein said conductive resin composition further contains a compatibility enhancing agent for enhancing a compatibility between said polyamide resin and said low water absorption resin.

7. A base body for a photosensitive drum according to claim 6, wherein said compatibility enhancing agent is either or both of maleic acid modified polypropylene and polystyrene-polymethlymethacrylate copolymer.

8. A base body for a photosensitive drum, which is obtained by molding a conductive resin composition into a cylindrical shape,
said resin composition containing a resin base material and a conductive agent,
wherein said conductive agent is carbon black having a DBP oil absorption amount in a range of 130 ml/100 g or more.

9. A base body for a photosensitive drum according to claim 8, wherein a content of said carbon black is in a range of 30 wt % or less.

10. A base body for a photosensitive drum according to claim 8, wherein said resin base material contains a polyamide resin obtained from metaxylylene diamine and adipic acid and/or a polyamide resin obtained from ε-caprolactam.

11. A base body for a photosensitive drum according to claim 8, wherein said conductive resin composition contains an inorganic filler for reinforcement.

12. A base body for a photosensitive drum, which is obtained by molding a conductive resin composition into a cylindrical shape,
said resin composition containing an inorganic filler for reinforcement,
wherein said inorganic filler for reinforcement is either or both of a micro-spherical inorganic material and a flake-shaped inorganic material.

13. A base body for a photosensitive drum according to claim 12, wherein said micro-spherical inorganic material is in the form of spherical particles having an average particle size in a range of 50 μm or less.

14. A base body for a photosensitive drum according to claim 12, wherein said micro-spherical inorganic material is one kind or two or more kinds selected from glass beads, silica balloon, and fly ash.

15. A base body for a photosensitive drum according to claims 12, wherein a content of said micro-spherical inorganic material is in a range of 10 to 25 wt %.

16. A base body for a photosensitive drum according to claim 12, wherein said flake-shaped inorganic material is in the form of flakes each having an aspect ratio (length/thickness) in a range of 10 to 70.

17. A base body for a photosensitive drum according to claim 12, wherein said flake-shaped inorganic material is one kind or two or more kinds selected from aluminum flakes, Ni-coated mica, muscovite, and phlogopite.

18. A base body for a photosensitive drum according to claim 12, wherein a content of said flake-shaped inorganic material is in a range of 10 to 25 wt %.

19. A base body for a photosensitive drum, which is obtained by molding a conductive resin composition into a cylindrical shape,
said resin composition containing an inorganic filler for reinforcement,
wherein said inorganic filler for reinforcement is a fibrous inorganic material in the form of fibers each having a length ranging from 8 to 50 μm and a diameter ranging from 0.1 to 5 μm.

20. A base body for a photosensitive drum according to claim 19, wherein said fibrous inorganic material is a fiber material in the form of whisker based fibers of one kind or two or more kinds selected from potassium titanate, aluminum borate, silicon carbonate, basic magnesium sulfate, zinc oxide, calcium sulfate, magnesium borate, and calcium silicate.

21. A base body for a photosensitive drum according to claim 19, wherein a content of said fibrous inorganic material is in a range of 10 to 25 wt % on the basis of the total weight of said conductive resin composition.

22. A base body for a photosensitive drum according to claim 19, wherein said base body has a surface roughness specified under JIS B0601 such that a center line average height Ra is in a range of less than 0.2 μm and a maximum height Rmax is in a range of less than 0.8 μm.

23. A base body for a photosensitive drum, which is obtained by molding a conductive resin composition into a cylindrical shape,
wherein said resin composition has a factor tan δ expressing a frequency characteristic of said resin composition measured by an one-end fixation method using an apparatus for measuring a complex modulus of elasticity, which factor is in a range of 0.05 or more.

24. A base body for a photosensitive drum according to claim 23, wherein said conductive resin composition further contains an inorganic filler for reinforcement.

25. A photosensitive drum comprising:
a cylindrical base body, which is obtained by molding a conductive resin composition into a cylindrical shape; and
a photosensitive layer formed on an outer peripheral surface of said cylindrical base body;
wherein said resin composition contains a resin base material and a conductive agent, and said resin base material is a mixed resin of a polyamide resin and a low water absorption resin.

26. A photosensitive drum according to claim 25, wherein said low water absorption resin has a water absorption specified under ASTM-D570, which percentage is in a range of 0.3% or less.

27. A photosensitive drum according to claim 25, wherein said low water absorption resin is one kind or two or more kinds selected from polypropylene, polyphenylene ether, and polyphenylene sulfide.

28. A photosensitive drum according to claim 25, wherein said polyamide resin is one kind or two or more kinds selected from polyamide resins including polyamide 11, polyamide 12, polyamide 46, polyamide 6, polyamide 66, polyamide MXD6, polyamide 610, polyamide 612, polyamide 1212, and copolymers thereof.

29. A photosensitive drum according to claim 25, wherein a content of said low water absorption resin is in a range of 1 to 70 wt % on the basis of the total weight of said resin base material.

30. A photosensitive drum according to claim 25, wherein said conductive resin composition further contains a compatibility enhancing agent for enhancing a compatibility between said polyamide resin and said low water absorption resin.

31. A photosensitive drum according to claim 30, wherein said compatibility enhancing agent is either or both of maleic acid modified polypropylene and polystyrene-polymethylmethacrylate copolymer.

32. A photosensitive drum comprising:
a cylindrical base body, which is obtained by molding a conductive resin composition into a cylindrical shape; and
a photosensitive layer formed on an outer peripheral surface of said cylindrical base body;
wherein said resin composition contains a resin base material and a conductive agent, and said conductive agent is carbon black having a DBP oil absorption amount in a range of 130 ml/100 g or more.

33. A photosensitive drum according to claim 32, wherein a content of said carbon black is in a range of 30 wt % or less.

34. A photosensitive drum according to claim 32, wherein said resin base material contains a polyamide resin obtained from metaxylylene diamine and adipic acid and/or a polyamide resin obtained from ε-caprolactam.

35. A photosensitive drum according to claim 32, wherein said conductive resin composition contains an inorganic filler for reinforcement.

36. A photosensitive drum comprising:
a cylindrical base body, which is obtained by molding a conductive resin composition into a cylindrical shape; and
a photosensitive layer formed on an outer peripheral surface of said cylindrical base body;
wherein said resin composition contains an inorganic filler for reinforcement, and said inorganic filler for reinforcement is either or both of a micro-spherical inorganic material and a flake-shaped inorganic material.

37. A photosensitive drum according to claim 36, wherein said micro-spherical inorganic material is in the form of spherical particles having an average particle size in a range of 50 μm or less.

38. A photosensitive drum according to claim 36, wherein said micro-spherical inorganic material is one kind or two or more kinds selected from glass beads, silica balloon, and fly ash.

39. A photosensitive drum according to claims 36, wherein a content of said micro-spherical inorganic material is in a range of 10 to 25 wt %.

40. A photosensitive drum according to claim 36, wherein said flake-shaped inorganic material is in the form of flakes each having an aspect ratio (length/thickness) in a range of 10 to 70.

41. A photosensitive drum according to claim 36, wherein said flake-shaped inorganic material is one kind or two or more kinds selected from aluminum flakes, Ni-coated mica, muscovite, and phlogopite.

42. A photosensitive drum according to claim 36, wherein a content of said flake-shaped inorganic material is in a range of 10 to 25 wt %.

43. A photosensitive drum comprising:
a cylindrical base body, which is obtained by molding a conductive resin composition into a cylindrical shape; and
a photosensitive layer formed on an outer peripheral surface of said cylindrical base body;
wherein said resin composition contains an inorganic filler for reinforcement, and said inorganic filler for reinforcement is a fibrous inorganic material in the form of fibers each having a length ranging from 8 to 50 μm and a diameter ranging from 0.1 to 5 μm.

44. A photosensitive drum according to claim 43, wherein said fibrous inorganic material is a fiber material in the form of whisker based fibers of one kind or two or more kinds selected from potassium titanate, aluminum borate, silicon carbonate, basic magnesium sulfate, zinc oxide, calcium sulfate, magnesium borate, and calcium silicate.

45. A photosensitive drum according to claim 43, wherein a content of said fibrous inorganic material is in a range of 10 to 25 wt % on the basis of the total weight of said conductive resin composition.

46. A photosensitive drum according to claim 43, wherein said base body has a surface roughness specified under JIS B0601 such that a center line average height Ra is in a range of less than 0.2 μm and a maximum height Rmax is in a range of less than 0.8 μm.

47. A photosensitive drum comprising:
a cylindrical base body, which is obtained by molding a conductive resin composition into a cylindrical shape; and
a photosensitive layer formed on said cylindrical base body;
wherein said resin composition has a factor tan δ expressing a frequency characteristic of said resin composition measured by an one-end fixation method using an apparatus for measuring a complex modulus of elasticity, which factor is in a range of 0.05 or more.

48. A photosensitive drum according to claim 47, wherein said conductive resin composition further contains an inorganic filler for reinforcement.
